(19) United States
(12) Patent Application Publication
(10) Pub. No.: US 2024/0337576 A1
(43) Pub. Date: Oct. 10, 2024

(54) WINDOW WITH FERROMAGNETIC MARKER FOR A MEASURING ARRANGEMENT, AND MEASURING ARRANGEMENT WITH SUCH A WINDOW

(71) Applicant: Endress+Hauser SE+Co. KG, Maulburg (DE)

(72) Inventors: Peter Klöfer, Steinen (DE); Sergey Lopatin, Lörrach (DE); Anh Tuan Tham, Berlin (DE); Volker Frey, Schopfheim (DE); Benjamin Scherer, Oberried (DE)

(21) Appl. No.: 18/293,398

(22) PCT Filed: Jul. 25, 2022
(86) PCT No.: PCT/EP2022/070739

§ 371 Date: Jan. 30, 2024

(30) Foreign Application Priority Data
Aug. 5, 2021 (DE) 10 2021 120 432.1

(51) Int. Cl. G01N 15/06; G01F 23/284; G01L 19/00; G01L 19/14; G01N 15/00

(52) U.S. Cl. CPC G01N 15/0656; G01F 23/284; G01L 19/0092; G01L 19/142; G01N 2015/0053

(57) ABSTRACT

The present disclosure relates to a measuring arrangement comprising a containment for a medium as well as to a measuring device for registering a property of the medium. The containment and/or the measuring device have/has, in each case, at least one apparatus, which apparatus includes a window to a lumen of the containment, wherein the window comprises a dielectric material, such as, for example, a glass or a ceramic, wherein the apparatus includes a ferromagnetic marking, which is adapted in case of a partial failure of the window to shed pieces into the medium, wherein a detector for detecting ferromagnetic materials is provided and adapted to check for presence of marking particles in the medium.

Measuring arrangements for measuring a property of a medium usually have a containment for holding/conveying the medium, as well as at least one measuring device. Media contacting parts of the containment, or of the measuring device, can for practical reasons be made of material having a tendency to shed pieces of itself. Such pieces can be small, such that a partial failure of a part can remain unnoticed.

An object of the invention is, thus, to provide a window for a measuring arrangement as well as a measuring arrangement, in the case of which such a partial failure can be detected.

The object is achieved by a window as defined in independent claim 1 and a measuring arrangement as defined in independent claim 5.

A window of the invention is adapted for service in a measuring arrangement comprising a containment for a medium and at least one measuring device for registering a property of the medium, wherein the window is adapted to be applied as a component of the containment or of the measuring device and to form a closure for a lumen of the containment,
wherein the window comprises a dielectric material,
characterized in that
the window includes a ferromagnetic marking, such that the window is adapted in case of a partial failure of the window to shed ferromagnetically marked pieces of itself.

In an embodiment, the marking is formed by a coating of a containment lumen faceable side of the window with a plurality of ferromagnetic marking particles,
and/or
wherein the dielectric material comprises at least in the region of a containment lumen faceable side a plurality of ferromagnetic marking particles.

In an embodiment, a concentration of the marking particles is defined by a number N per cubic millimeter,
wherein at least in a region of an interface between medium and dielectric material N is greater than 100, especially greater than 500, and, preferably, greater than 1000
and/or wherein N is less than 1,000,000, especially less than 50,000, and, preferably, less than 10,000.

In an embodiment, a volume of a marking particle is, in each case,
at least 1 cubic micrometer
and/or
at most 100,000 cubic micrometer.

A measuring arrangement of the invention comprises a containment for a medium as well as a measuring device for registering a property of the medium,
wherein the containment and/or the measuring device have/has, in each case, at least one window to a lumen of the containment, wherein the window comprises a dielectric material, such as, for example, a glass or a ceramic,
wherein the window includes a ferromagnetic marking, which is adapted in case of a partial failure to shed pieces into the medium,
wherein a detector for detecting ferromagnetic materials is provided and adapted to check for presence of marking particles in the medium.

A shed piece producing, partial failure of a component of the measuring arrangement can, thus, be detected in simple manner and a warning report issued.

A containment can be, for example, a tank or a measuring tube or a pipeline.

In an embodiment, the marking is formed by a coating of a containment lumen faceable side of the window with a plurality of ferromagnetic marking particles,
and/or
wherein the dielectric material comprises at least in the region of a lumen facing interface a plurality of ferromagnetic marking particles.

In an embodiment, a concentration of the marking particles is defined by a number N per cubic millimeter,
wherein at least in a region of an interface between medium and dielectric material N is greater than 100, especially greater than 500, and, preferably, greater than 1000
and/or wherein N is less than 1,000,000, especially less than 50,000, and, preferably, less than 10,000.

In this way, it can be assured that a sufficiently great fraction of arising shed pieces contains at least one marking particle, such that a partial failure can be detected early.

In this way, it can be assured that the marking particles cause in the dielectric material an only low influencing of the dielectric material.

In an embodiment, a volume of a marking particle amounts, in each case,
to at least 1 cubic micrometer
and/or
at most 100,000 cubic micrometer.

In this way, a good detectability is provided. The upper limit prevents a disturbing influence of the marking particles, for example, in case of a viewing window.

In an embodiment, the detector is arranged in the region of a drain of the containment.

In this way, the probability that shed pieces are detected is increased.

In an embodiment, the detector is adapted to detect marking particles by establishing a magnetic flux density change.

In an embodiment, the detector comprises, for example:
a quantum magnetometer,
a fluxgate magnetometer,
a giant magnetoresistance magnetometer.

Quantum magnetometers operate based, for example, on nitrogen vacancy centers in diamonds, whose spectroscopic properties depend on external influences, such as, for example, a present magnetic field. These properties can then be queried, for example, by means of microwave radiation, from which information relative to the external magnetic field can be derived. Such quantum magnetometers have especially high sensitivity and are, consequently, advantageous for detecting such shed pieces.

In an embodiment, the detector is adapted to sense a magnetic field in at least two and, especially, three directions.

In this way, it can be avoided that a shed piece produces a magnetic field directed unfavorably for the detector or distorts a field produced by permanent magnets. A direction dependent measuring can prove useful in the case of asymmetric particles.

In an embodiment, the measuring device is a pressure measuring device having a pressure measuring cell comprising a ceramic material, or a radar fill level measuring device having transmitting/receiving means comprised of a ceramic material,
wherein the ceramic material contains the ferromagnetic marking.

In an embodiment, the containment includes a viewing window having a ferromagnetic marking.

The invention will now be described based on examples of embodiments presented in the appended drawing, the figures of which show as follows:

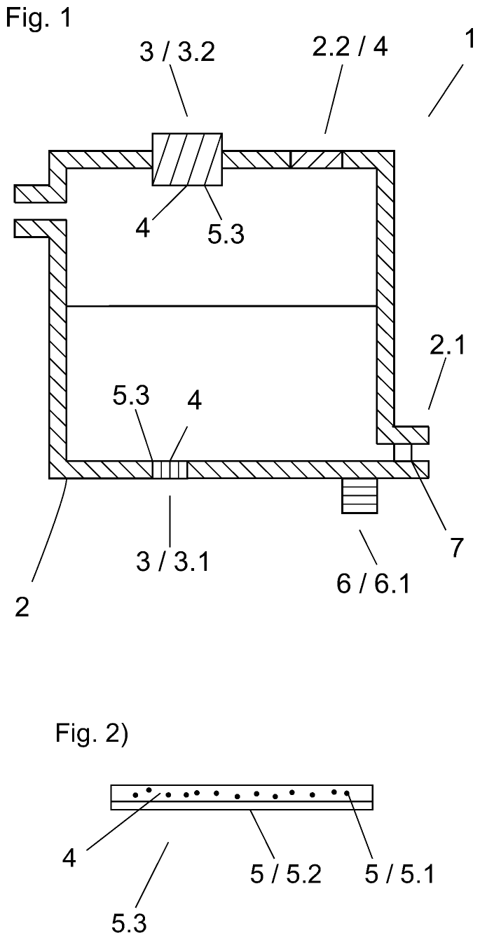

FIG. 1 by way of example, a cross section of a measuring arrangement of the invention;

FIG. 2 a schematic, sectional enlargement of an example a window of the invention.

FIG. 1 shows, by way of example, a measuring arrangement 1 of the invention, including a containment 2, in which a medium is located, and measuring devices 3. The containment can, such as shown here, have a supply line, and a drain 2.1, which, such as shown here, can be equipped with a valve 7. The containment can, such as shown here, have a window 4 in the form of a viewing window. As shown here by way of example, a measuring device can be embodied as a pressure measuring device 3.1 or as a contactless, fill level measuring device 3.2. A measuring arrangement of the invention can also have only one measuring device or more than two measuring devices. Measuring devices such as fill level measuring devices or pressure measuring devices usually have a window 4 bordering a lumen of the containment and composed of a dielectric material, such as a glass or a ceramic. Such measuring devices having a window of a dielectric material are susceptible to partial failure, in the case of which shed pieces can arise. For example, the window in case of a pressure measuring device can be in the form of a ceramic diaphragm, whose pressure-dependent deflection is taken into consideration for pressure measurement. Such can be accomplished, for example, by measuring an electrical capacitance between the ceramic diaphragm and an additional component of the pressure measuring device.

According to the invention, at least one such window includes a ferromagnetic marking 5, which is adapted in case of a partial failure of the window to issue ferromagnetically marked, shed pieces into the medium. The marking 5 can be embodied, for example, as a coating 5.2 of the window; compare FIG. 2. Alternatively or supplementally, the window can contain ferromagnetic, marking particles 5.1; compare FIG. 2.

According to the invention, the measuring arrangement includes at least one detector adapted for detecting ferromagnetic marking particles 5.1. In an embodiment, the detector is embodied, for example, in the form of a quantum magnetometer. In case the containment, such as shown here, includes a drain 2.1, the detector is advantageously arranged in the region of the drain, since an increased concentration of shed pieces can be expected there.

Quantum magnetometers operate based, for example, on nitrogen vacancy centers in diamond. The spectroscopic properties of such nitrogen vacancy centers depend on external influences, such as, for example, a present magnetic field. These properties can be queried, for example, by means of microwave radiation, in order to derive information concerning an external magnetic field. Such quantum magnetometers exhibit an especially high sensitivity and are, consequently, advantageous for detecting such shed pieces.

Alternatively, the containment can also be a measuring tube adapted for conveying the medium.

FIG. 2 shows a schematic, sectional enlargement of an example of a window of the invention, wherein the ferromagnetic marking 5 is formed, as shown here by way of example, by the coating 5.2 on a containment lumen faceable side of the window 4 as well as by ferromagnetic marking particles 5.1 contained in the window. The marking 5 can also be formed exclusively by the coating 5.2 or by the marking particles 5.1.

In an embodiment, the ferromagnetic marking particles have a concentration defined by a number N per cubic millimeter,
wherein at least in a region of an interface between medium and dielectric material, N is greater than 100, and especially greater than 500, and, preferably, greater than 1000,
and/or wherein N is less than 1,000,000, and, especially, less than 50,000, and, preferably, less than 10,000.

The lower limit assures that a sufficiently great part of arising shed pieces contains at least one marking particle, such that a partial failure can be detected early. The upper limit assures that the marking particles bring about in the dielectric material an only minor influencing of the dielectric material.

In an embodiment, volume of a marking particle 5.1 is, in each case, at least 1 cubic micrometer and/or at most 100,000 cubic micrometer.

In this way, it can be assured that the marking particles bring about in the dielectric material an only minor influencing of the dielectric material.

The lower limit assures a sufficient magnetic effect, while the upper limit assures that the marking particles bring about in the dielectric material an only minor influencing of the dielectric material.

### LIST OF REFERENCE CHARACTERS

1 measuring arrangement
2 containment
2.1 drain
2.2 viewing window
3 measurement device
3.1 pressure measuring device
3.2 radar fill level measuring device
4 window
5 ferromagnetic marking
5.1 ferromagnetic marking particles
5.2 coating
5.3 containment lumen faceable side of the window
6 detector
6.1 quantum magnetometer
7 valve

The invention claimed is:

1-11. (canceled)

12. A window adapted for a measuring arrangement comprising a containment for a medium and at least one measuring device for registering a property of the medium, wherein the window is adapted to be applied as a component of the containment or of the measuring device and to form a closure for a lumen of the containment,
wherein the window comprises a dielectric material,
wherein the window includes a ferromagnetic marking, such that the window is adapted in case of a partial failure of the window to shed ferromagnetically marked pieces of itself.

13. The window as claimed in claim 12,
wherein the marking is formed by a coating of a containment lumen faceable side of the window with a plurality of ferromagnetic marking particles,
and/or
wherein the dielectric material comprises at least in the region of a containment lumen faceable side a plurality of ferromagnetic marking particles.

14. The window as claimed in claim 13,
wherein a concentration of the marking particles is defined by a number N per cubic millimeter,
wherein at least in a region of an interface between medium and dielectric material N is greater than 100 and/or wherein N is less than 1,000,000.

15. The window as claimed in claim 12,
wherein a volume of a marking particle is, in each case,
at least 1 cubic micrometer
and/or
at most 100,000 cubic micrometer.

16. A measuring arrangement comprising a containment for a medium as well as a measuring device for registering a property of the medium,
wherein the containment and/or the measuring device have/has, in each case, at least one window as claimed in one of the preceding claims to a lumen of the containment, wherein the window comprises a dielectric material, such as, for example, a glass or a ceramic,
wherein
the window includes a ferromagnetic marking, which is adapted in case of a partial failure of the window to shed ferromagnetically marked pieces into the medium.

17. The measuring arrangement as claimed in claim 16,
wherein a detector for detecting ferromagnetic materials is provided and adapted to check for presence of marking particles in the medium,
wherein the detector is arranged in the region of a drain of the containment.

18. The measuring arrangement as claimed in claim 17,
wherein the detector is adapted to detect marking particles by establishing a magnetic flux density change.

19. The measuring arrangement as claimed in claim 18,
wherein the detector comprises:
a quantum magnetometer based on nitrogen vacancy centers in diamond,
a fluxgate magnetometer,
a giant magnetoresistance magnetometer.

20. The measuring arrangement as claimed in claim 17,
wherein the detector is adapted to sense a magnetic field in at least two directions.

21. The measuring arrangement as claimed in claim 16,
wherein the measuring device is a pressure measuring device having a pressure measuring cell comprising a ceramic material or a radar fill level measuring device having transmitting/receiving means comprised of a ceramic material,
wherein the ceramic material contains the ferromagnetic marking.

22. The measuring arrangement as claimed in claim 16, wherein the window is a viewing window.
